(19) United States
(12) Patent Application Publication
(10) Pub. No.: US 2025/0144567 A1
(43) Pub. Date: May 8, 2025

(54) CATALYST WITH REGULAR STRUCTURE AND PREPARATION METHOD THEREOF AND METHOD FOR SIMULTANEOUSLY REDUCING BOTH SOX AND NOX FROM FLUE GAS

(71) Applicants: CHINA PETROLEUM & CHEMICAL CORPORATION, Beijing (CN); SINOPEC RESEARCH INSTITUTE OF PETROLEUM PROCESSING CO., LTD., Beijing (CN)

(72) Inventors: Qiuqiao JIANG, Beijing (CN); Haitao SONG, Beijing (CN); Dongyue ZHAO, Beijing (CN); Menglong FENG, Beijing (CN); Yakun QU, Beijing (CN); Hao SHA, Beijing (CN)

(21) Appl. No.: 18/690,993

(22) PCT Filed: Sep. 9, 2022
(86) PCT No.: PCT/CN2022/118239

§ 371 Date: Mar. 11, 2024

(30) Foreign Application Priority Data
Sep. 9, 2021 (CN) 202111054723.6
Sep. 9, 2021 (CN) 202111055118.0

(51) Int. Cl. B01D 53/86; B01J 23/89; B01J 35/56; B01J 37/02; B01J 37/03

(52) U.S. Cl. CPC B01D 53/8637; B01J 23/8986; B01J 35/56; B01J 37/0242; B01J 37/038; B01D 2255/2063; B01D 2257/302; B01D 2257/404; B01D 2258/0283

(57) ABSTRACT

The present invention relates to the field of catalytic cracking, and discloses a catalyst with regular structure capable of simultaneously reducing the emission of SOx and NOx and a preparation method thereof, and a method for simultaneously reducing both SOx and NOx from flue gas, the catalyst comprises a support with regular structure and an active component coating distributed on the inner surface and/or the outer surface of the support with regular structure, the active metal component contains: 1) as oxide, 50-95 wt % of metal component(s) selected from Group rare earth and/or Group IIA; 2) as oxide, 5-50 wt % of non-precious metal component(s) selected from Groups VB, VIIB, VIII, IB, and IIB; 3) as element, 0.01-2 wt % of precious metal component. Using the catalyst provided by the invention can reduce the total amount of added active components and enhance the emission reduction effect of the additive.

### TECHNICAL FIELD

The present invention relates to a catalyst with regular structure capable of simultaneously reducing the emission of SOx and NOx and a preparation method thereof, and a method for simultaneously reducing both SOx and NOx from flue gas.

### BACKGROUND

During the catalytic cracking reaction, coke is deposited on the catalyst due to the reaction of hydrocarbons, which reduces the catalyst activity. After the coke-containing catalyst is separated from the hydrocarbons adsorbed on the catalyst through the stripping section, it is transported to the regenerator. In the regenerator, the coke-containing catalyst is fully contacted with the air at high temperature, and the coke on the catalyst surface is burned off, allowing the catalyst activity to be restored. When the coke is burned off the catalyst, SOx and NOx are generated, and these gases are emitted into the air and cause atmospheric pollution. As environmental protection requirements become more and more stringent, emission standards for flue gas pollutants are becoming more and more stringent.

The main technical measures to reduce catalytic cracking regeneration flue gas include: the regenerator optimization, the flue gas post-treatment and the use of additives. The post-treatment technologies, such as the SCR process that can use ammonia injection to reduce NOx, and the wet desulfurization technology that can use alkali injection to absorb SO₂, however require high equipment investment and have high operation costs, and have problems such as ammonia escape and blue smoke tailing. The current mainstream desulfurization and denitrification additives mainly remove one flue gas pollutant alone. For example: CN1334316A discloses a sulfur transfer agent comprising a magnesia-alumina spinel-containing composition and a Ce/V oxide, which is used to remove SOx from the catalytic cracking flue gas; CN101311248B provides a composition capable of reducing the emission of NOx in the catalytic cracking regeneration flue gas, which is used to reduce NOx in the catalytic cracking flue gas.

The above-mentioned processes and patent documents have good removal effects when separately removing SOx or NOx in the regeneration flue gas, but they cannot remove nitrogen oxides and sulfur oxides at the same time/simultaneously.

### SUMMARY OF THE INVENTION

The purpose of the present invention is to overcome the above problems in the existing art, and to provide a catalyst with regular structure capable of simultaneously reducing the emission of SOx and NOx and a preparation method thereof, and a method for simultaneously reducing both SOx and NOx from catalytic cracking regeneration flue gas. The use of the catalyst provided by the present invention can reduce its total addition amount and enhance the emission reduction effect of the additive.

In order to achieve the above object, the first aspect of the present invention provides a catalyst with regular structure capable of simultaneously reducing the emission of SOx and NOx, the catalyst comprises a support with regular structure and an active component coating distributed on the inner surface and/or the outer surface of the support with regular structure, based on the total weight of the catalyst, the content of the active component coating is 1-50 wt %, the active component coating contains a matrix and an active metal component, wherein, based on the total weight of the active component coating, the content of the matrix is 10-90 wt %, the content of the active metal component is 10-90 wt %, the active metal component contains: 1) as oxide, 50-95 wt % of metal component(s) selected from Group rare earth and/or Group IIA; 2) as oxide, 5-50 wt % of non-precious metal component(s) selected from Groups VB, VIIB, VIII, IB, and IIB; 3) as element, 0.01-2 wt % of precious metal component.

In the present invention, in the absence of contrary teaching, “based on the total weight of the catalyst” means that the total weight of the catalyst is 100 wt %; “based on the total weight of the active component coating” means that the total weight of the active component coating is 100 wt %; when referring to the constitution and content of an active metal component, in the absence of a definitive basis, the basis is established on that the total weight of said active metal component is 100 wt %.

The second aspect of the present invention provides a method for preparing a catalyst with regular structure capable of simultaneously reducing the emission of SOx and NOx, which method comprises the steps of:
(1) formulating a solution containing a precursor of metal component(s) selected from Group rare earth and/or Group IIA and a precursor of non-precious metal component(s) selected from Groups VB, VIIB, VIII, IB, and IIB;
(2) carrying out a coprecipitation reaction between the solution obtained in step (1) and a coprecipitant, and then drying and calcining the obtained solid product to obtain an active metal component precursor;
(3) mixing and slurrifying the active metal component precursor, a matrix source and water to produce an active component coating slurry;
(4) coating the support with regular structure with the active component coating slurry and drying and calcining to produce a partial-active component coating distributed on the inner surface and/or the outer surface of the support with regular structure, i.e. to obtain a semi-finished catalyst product;
(5) impregnating the semi-finished catalyst product obtained in step (4) with a solution containing a precursor of precious metal component, then drying and/or calcining to produce an active component coating distributed on the inner surface and/or the outer surface of the support with regular structure;
wherein the precursor of metal component(s) selected from Group rare earth and/or Group IIA, the precursor of non-precious metal component(s) selected from Groups VB, VIIB, VIII, IB, and IIB, the matrix source, the precursor of precious metal component, and the support with regular structure are used in such amounts that in the prepared catalyst with regular structure, based on the total weight of the catalyst, the content of the active component coating is 1-50 wt %, the active component coating contains a matrix and an active metal component, wherein, based on the total weight of the active component coating, the content of the matrix is 10-90 wt %, the content of the active metal component is 10-90 wt %, the active metal component contains: 1) as oxide, 50-95 wt % of metal component(s) selected from Group rare earth and/or Group IIA; 2) as oxide, 5-50 wt % of non-precious metal component(s) selected from Groups VB, VIIB, VIII, IB, and IIB; 3) as element, 0.01-2 wt % of precious metal component.

The third aspect of the present invention provides a method for simultaneously reducing both SOx and NOx from catalytic cracking regeneration flue gas, which method comprises: contacting the catalytic cracking regeneration flue gas with a catalyst under a condition for removing SOx and NOx, wherein the catalyst is a catalyst with regular structure capable of simultaneously reducing the emission of SOx and NOx according to the first aspect of the present invention or a catalyst with regular structure capable of simultaneously reducing the emission of SOx and NOx prepared with the preparation method according to the second aspect of the present invention.

Based on the purpose of combined removal of SOx and NOx, the present invention develops a new catalyst for combined removal of flue gas pollutants. The catalyst with regular structure capable of simultaneously reducing the emission of SOx and NOx provided by the present invention has high activity in the combined removal of pollutants, can be simply prepared, and can effectively reduce the emission of SOx and NOx in catalytic cracking regeneration flue gas. The catalyst provided by the invention is a regular material and can be put into the flue gas channel for direct use. In addition, the use of the catalyst provided by the invention can reduce its total addition amount, enhance the emission reduction effect of the additive, and greatly improve the competitiveness of the additive technology.

### DETAILED DESCRIPTION OF THE INVENTION

The endpoints of ranges and any values disclosed herein are not limited to such precise ranges or values. Still, these ranges or values should be understood to include values approaching such ranges or values. For numerical ranges, a combination between any two of the endpoint values of ranges, a combination between one of the endpoint values of ranges and an individual point value, or a combination between any two of individual point values can be made to obtain one or more new numerical ranges. These numerical ranges shall be deemed to be specifically disclosed herein.

In the present invention, the used term “catalyst with regular structure” refers to a catalyst comprising a support with regular structure and an active component coating distributed on the inner surface and/or the outer surface of the support; and the term “support with regular structure” refers to a support having a regular structure.

The first aspect of the present invention provides a catalyst with regular structure capable of simultaneously reducing the emission of SOx and NOx, the catalyst comprises a support with regular structure and an active component coating distributed on the inner surface and/or the outer surface of the support with regular structure, based on the total weight of the catalyst, the content of the active component coating is 1-50 wt %, the active component coating contains a matrix and an active metal component, wherein, based on the total weight of the active component coating, the content of the matrix is 10-90 wt %, the content of the active metal component is 10-90 wt %, the active metal component contains: 1) as oxide, 50-95 wt % of metal component(s) selected from Group rare earth and/or Group IIA; 2) as oxide, 5-50 wt % of non-precious metal component(s) selected from Groups VB, VIIB, VIII, IB, and IIB; 3) as element, 0.01-2 wt % of precious metal component.

In the catalyst with regular structure provided by the present invention, specific types and contents of active components exist in the form of an active metal component coating on the inner surface and/or the outer surface of the support with regular structure. The active metal dispersion in the coating is relatively high. The activity of reducing SOx and NOx is significantly improved.

According to a preferable embodiment of the present invention, based on the total weight of the catalyst, the content of the active component coating is 5-40 wt %, preferably 10-35 wt %.

According to the catalyst with regular structure provided by the present invention, preferably, based on the total weight of the active component coating, the content of the matrix is 40-90 wt %, the content of the active metal component is 10-60 wt %; further preferably, the content of the matrix is 50-80 wt %, the content of the active metal component is 20-50 wt %.

According to the catalyst with regular structure provided by the present invention, preferably, the active metal component contains: 1) as oxide, 60-90 wt % of metal component(s) selected from Group rare earth and/or Group IIA; 2) as oxide, 10-40 wt % of non-precious metal component(s) selected from Groups VB, VIIB, VIII, IB, and IIB; 3) as element, 0.02-1.5 wt % of precious metal component.

Further more preferably, the active metal component contains: 1) as oxide, 65-85 wt % of metal component(s) selected from Group rare earth and/or Group IIA; 2) as oxide, 15-35 wt % of non-precious metal component(s) selected from Groups VB, VIIB, VIII, IB, and IIB; 3) as element, 0.03-1.2 wt % of precious metal component.

According to a preferable embodiment of the present invention, the active metal component contains both the rare earth metal component and the Group IIA metal component at the same time. With this preferred embodiment, it is more conducive to improving the ability of the catalyst in simultaneously removing SOx and NOx in flue gas. Further preferably, based on the total weight of the active metal component, the content of the rare earth metal component is 30-80 wt %, further preferably 40-75 wt %; and the content of the Group IIA metal component is 5-40 wt %, further preferably 10-30 wt %.

According to a preferable embodiment of the present invention, the active metal component contains the non-precious metal component(s) selected from Groups VB, VIII, IB, and IIB and the Group VIIB non-precious metal component at the same time. With this preferred embodiment, it is more conducive to improving the ability of the catalyst in simultaneously removing SOx and NOx in flue gas. Further preferably, based on the total weight of the active metal component, the content of non-precious metal component(s) selected from Groups VB, VIII, IB, and IIB is 3-30 wt %, preferably 5-20 wt %; the content of the Group VIIB non-precious metal component is 3-20 wt %, preferably 5-15 wt %.

According to a particularly preferable embodiment of the present invention, the molar ratio of La:Co is (0.5-15): 1, e.g. (1-10): 1, or (1-6): 1, (2-5): 1, or (2.5-3.5): 1, or (2.6-3.4): 1, or (2.7-3.3): 1, or (2.8-3.2): 1, or (2.9-3.1): 1, or (2.95-3.05): 1. Adopting this preferred embodiment is more conducive to improving the performance of the catalyst in combined removal of SOx and NOx. In the present invention, the contents of components in a catalyst with regular structure are determined using the X-ray fluorescence spectroscopy (Petrochemical Analysis Methods (RIPP Experimental Methods), edited by Yang Cuiding et al., published by Science Press in 1990). In the present invention, a Siemens D5005 diffractometer is used to perform powder X-ray diffraction (XRD) analysis on the catalyst sample, in which CuKa (2-0.15418 nm) radiation is generated under the conditions of 40 kV, 40 mA and filtered by Ni. Diffraction signals are recorded in the range of 2θ 5-70° with a step of 0.02°.

According to the present invention, conventionally defined rare earth metal(s) all can be used in the present invention. In order to further improve the performance of the catalyst with regular structure in simultaneously removing SOx and NOx, it is preferred that the rare earth metal component is one or more of La, Ce, Pr and Nd, more preferably La and/or Ce, more preferably La.

According to the present invention, said Group IIA metal component is one or more of Be, Mg, Ca, Sr and Ba, preferably Mg.

According to the present invention, the Group VB non-precious metal component can be one or more V, Nb and Ta; preferably, the Group VIIB non-precious metal component is Mn; the Group VIII non-precious metal component can be at least one of Fe, Co and Ni; the Group IB non-precious metal component can be Cu; the Group IIB non-precious metal component can be at least one of Zn, Cd and Hg.

Preferably, said non-precious metal component(s) selected from Groups VB, VIIB, VIII, IB, and IIB is one or more of Mn, Fe, Co, Ni, Cu, Zn and V, more preferably at least one of Co, Fe and Mn, further more preferably Mn, and Co and/or Fe, most preferably Mn and Co.

According to the catalyst with regular structure provided by the present invention, preferably, said precious metal component is one or more of Ru, Rh, Re, Pt, Pd, Ag, Ir and Au, more preferably one or more of Pt, Pd and Rh, most preferably Pd.

According to the catalyst with regular structure provided by the present invention, preferably, the matrix is at least one of alumina, spinel, perovskite, silica-alumina, zeolite, kaolin, diatomaceous earth, and perlite, preferably at least one of alumina, spinel, and perovskite, further preferably at least one of alumina, spinel and perovskite, further more preferably alumina. With respect to the catalyst with regular structure of the present invention, the support with regular structure can be used for the catalyst bed provided in the fixed bed reactor. The support with regular structure can be a monolithic support block with hollow channel structure formed inside. A catalyst coating can be distributed on the inner wall of the channels, and the channel space can be used as the space for the fluid flowing. Preferably, the support with regular structure is selected from monolithic supports with parallel channel structure open at both ends. The support with regular structure can be a honeycomb regular support with honeycomb openings in cross-section (abbreviated as honeycomb support).

According to the catalyst with regular structure of the present invention, preferably the cross-section of the support with regular structure has a hole density of 10-300 holes/square inch, preferably 20-300 holes/square inch; the cross-section of the support with regular structure has an opening rate of 20-80%, preferably 50-80%. The holes may be of regular shape or irregular shape. The shapes of the holes may be identical or different. Each hole may independently be one of a square, an equilateral triangle, a regular hexagon, a circle, and a corrugated shape.

According to the catalyst with regular structure of the present invention, preferably said support with regular structure can be at least one of cordierite honeycomb support, mullite honeycomb support, diamond honeycomb support, corundum honeycomb support, fused-zirconia-alumina honeycomb support, quartz honeycomb support, nepheline honeycomb support, feldspar honeycomb support, alumina honeycomb support, and metal alloy honeycomb support. The present invention does not exclude that the rare earth metal elements, the Group IIA metal elements, and the non-precious metal elements selected from Groups IVB, VB, VIB, VIIB, VIII, IB and IIB contain other elements such as Sr, Ca and Ni, besides La, Co, Mg and Mn.

According to a particularly preferable embodiment of the present invention, the catalyst comprises a support with regular structure and an active component coating distributed on the inner surface and/or the outer surface of the support with regular structure, based on the total weight of the catalyst, the content of the active component coating is 10-35 wt %, the active component coating contains a matrix and an active metal component, wherein, based on the total weight of the active component coating, the content of the matrix is 50-80 wt %, the content of the active metal component is 20-50 wt %, the active metal component contains: 1) as oxide, 65-85 wt % of metal component(s) selected from Group rare earth and/or Group IIA; 2) as oxide, 15-35 wt % of non-precious metal component(s) selected from Groups VB, VIIB, VIII, IB, and IIB; 3) as element, 0.03-1.2 wt % of precious metal component; the rare earth metal component is La, the Group IIA metal component is Mg, said non-precious metal component(s) selected from Groups VB, VIIB, VIII, IB, and IIB is Mn and Co, and the precious metal component is Pd. With this particularly preferred embodiment, using La, Co, Mg, Mn and precious metal as metal elements in combination can greatly improve the ability to remove SOx and NOx, and the NOx adsorbed by the catalyst can also promote the catalyst to absorb SOx.

In the present invention, unless otherwise specified, La as oxide refers to La as La₂O₃, Mg as oxide refers to Mg as MgO, Co as oxide refers to Co as CO₂O₃, Mn as oxide refers to Mn as MnO.

The second aspect of the present invention provides a method for preparing a catalyst with regular structure capable of simultaneously reducing the emission of SOx and NOx, which method comprises the steps of:
(1) formulating a solution containing a precursor of metal component(s) selected from Group rare earth and/or Group IIA and a precursor of non-precious metal component(s) selected from Groups VB, VIIB, VIII, IB, and IIB;
(2) carrying out a coprecipitation reaction between the solution obtained in step (1) and a coprecipitant, and then drying and calcining the obtained solid product to obtain an active metal component precursor;
(3) mixing and slurrifying the active metal component precursor, a matrix source and water to produce an active component coating slurry;
(4) coating the support with regular structure with the active component coating slurry and drying and calcining to produce a partial-active component coating distributed on the inner surface and/or the outer surface of the support with regular structure, i.e. to obtain a semi-finished catalyst product;
(5) impregnating the semi-finished catalyst product obtained in step (4) with a solution containing a precursor of precious metal component, then drying and/or calcining to produce an active component coating distributed on the inner surface and/or the outer surface of the support with regular structure;
wherein the precursor of metal component(s) selected from Group rare earth and/or Group IIA, the precursor of non-precious metal component(s) selected from Groups VB, VIIB, VIII, IB, and IIB, the matrix source, the precursor of precious metal component, and the support with regular structure are used in such amounts that in the prepared catalyst with regular structure, based on the total weight of the catalyst, the content of the active component coating is 1-50 wt %, the active component coating contains a matrix and an active metal component, wherein, based on the total weight of the active component coating, the content of the matrix is 10-90 wt %, the content of the active metal component is 10-90 wt %, the active metal component contains: 1) as oxide, 50-95 wt % of metal component(s) selected from Group rare earth and/or Group IIA; 2) as oxide, 5-50 wt % of non-precious metal component(s) selected from Groups VB, VIIB, VIII, IB, and IIB; 3) as element, 0.01-2 wt % of precious metal component.

According to the preparation method provided by the present invention, the selection ranges for specific types of the rare earth metal component, the Group IIA metal component, the non-precious metal component(s) selected from Groups VB, VIIB, VIII, IB and IIB, and the precious metal component, the mxtrix, and the support with regular structure have been mentioned in the first aspect above, and will not be described in detail again here.

Preferably, the matrix source is a substance that can be transformed into the matrix under calcining in step (4). Those skilled in the art can make an appropriate selection according to the type of the above-mentioned matrix, and the present invention has no special limitation thereto. In case that the matrix is preferably alumina, the matrix source can be a precursor of alumina, for example the matrix source is at least one of gibbsite, bayerite, nordshandite, diaspore, boehmite, and pseudo-boehmite, most preferably pseudo-boehmite.

According to the method of the present invention, in case that the matrix is alumina, preferably, before slurrifying, the matrix source is subjected to acidification and peptization treatment, the acidification and peptization treatment can be carried out according to conventional technical means in the art, further preferably, the used acid in the acidification and peptization treatment is hydrochloric acid.

The present invention has a relatively wide selection range for the condition of acidification and peptization treatment, preferably, the condition of acidification and peptization treatment includes: the acid/alumina ratio is 0.12-0.22:1, the time is 10-40 min.

In the present invention, unless otherwise specified, the acid/alumina ratio refers to the mass ratio of hydrochloric acid based on 36 wt % of concentrated hydrochloric acid to the precursor of alumina based on dry basis.

According to the present invention, preferably, the precursor of metal component(s) selected from Group rare earth and/or Group IIA and the precursor of non-precious metal component(s) selected from Groups VB, VIIB, VIII, IB, and IIB can be each independently selected from water-soluble salts such as nitrates, chlorides, chlorates and sulfates, preferably nitrates and/or chlorides of metal components. In particular, the precursor of Mn can be potassium permanganate and/or manganese chloride.

The present invention has no special limitation on the method for obtaining the solution in step (1), as long as the precursors of metal components are mixed evenly. For example, the precursors of metal components can be dissolved in water and stirred thoroughly.

According to a preferable embodiment of the present invention, the precursor of metal component(s) selected from Group rare earth and/or Group IIA, the precursor of non-precious metal component(s) selected from Groups VB, VIIB, VIII, IB, and IIB, the matrix source, the precursor of precious metal component, and the support with regular structure are used in such amounts that in the prepared catalyst with regular structure, based on the total weight of the catalyst, the content of the active component coating is 5-40 wt %, the active component coating contains a matrix and an active metal component, wherein, based on the total weight of the active component coating, the content of the matrix is 40-90 wt %, the content of the active metal component is 10-60 wt %, the active metal component contains: 1) as oxide, 60-90 wt % of metal component(s) selected from Group rare earth and/or Group IIA; 2) as oxide, 10-40 wt % of non-precious metal component(s) selected from Groups VB, VIIB, VIII, IB, and IIB; 3) as element, 0.02-1.5 wt % of precious metal component.

Further preferably, the precursor of metal component(s) selected from Group rare earth and/or Group IIA, the precursor of non-precious metal component(s) selected from Groups VB, VIIB, VIII, IB, and IIB, the matrix source, the precursor of precious metal component, and the support with regular structure are used in such amounts that in the prepared catalyst with regular structure, based on the total weight of the catalyst, the content of the active component coating is 10-35 wt %, the active component coating contains a matrix and an active metal component, wherein, based on the total weight of the active component coating, the content of the matrix is 50-80 wt %, the content of the active metal component is 20-50 wt %, the active metal component contains: 1) as oxide, 65-85 wt % of metal component(s) selected from Group rare earth and/or Group IIA; 2) as oxide, 15-35 wt % of non-precious metal component(s) selected from Groups VB, VIIB, VIII, IB, and IIB; 3) as element, 0.03-1.2 wt % of precious metal component.

According to the method of the present invention, with respect to the method for providing the active metal component precursor, either a co-precipitation method may be used, or a sol-gel method may be used. More preferably, the co-precipitation method is used. However it should be understood that the sol-gel method is also within the protection scope of the present invention. The type and amount of the coprecipitant of the present invention can be selected according to conventional technical means, as long as the coprecipitation reaction can proceed smoothly. The type of the coprecipitant can be conventionally selected in the art, preferably, the coprecipitant is a carbonate salt, further preferably at least one of ammonium carbonate, potassium carbonate and sodium carbonate, more preferably ammonium carbonate.

In step (2), the coprecipitant can be introduced in the form of solution to carry out a coprecipitation reaction with the solution. The present invention has no particular limitation on the concentrations of the solution and the coprecipitant solution, as long as the solution concentration is less than the solubility when providing the solution, thereby ensuring that the coprecipitation reaction can fully occur.

Preferably, the coprecipitation reaction is carried out at pH=8-10, preferably 8.5-9.5. The pH of the coprecipitation reaction can be adjusted by adding acids and/or bases, the specific types of which are not particularly limited, for example, ammonia water. The present invention has no particular limitation on the temperature of the coprecipitation reaction, and the coprecipitation reaction can be carried out at room temperature.

According to the method of the present invention, the method also includes the reaction product obtained by the coprecipitation reaction is subjected to a solid-liquid separation (for example, filtering or centrifugal separation) to produce the solid product.

Preferably, the condition for calcining in step (2) includes: the temperature is 300-800° C., the time is 1-8 h.

In the present invention, preferably, in step (3), the active component coating slurry has a solid content of 5-45 wt %.

According to the present invention, the method of mixing and slurrifying the active metal component precursor, the matrix source and water is not particularly limited, and the addition order of the active metal component precursor, the matrix source and water is also not limited, as long as the active metal component precursor, the matrix source and water can be contacted and then slurrified to produce the slurry.

In the present invention, the content of the active component coating can be adjusted by adjusting the parameters during the coating process. For example, the amounts of the active component coating slurry and the support with regular structure used during the coating process can be adjusted.

In the method of the present invention, the coating can be to apply an active component coating slurry on the inner surface and/or the outer surface of the support with regular structure using various coating methods; and the coating method can be water coating, dipping or spraying. The specific coating operation can be carried out with reference to the method described in CN1199733C. Preferably, a water coating method is used as the coating method. During the coating process, one end of the support with regular structure is immersed in the active component coating slurry, and a vacuum is applied at the other end to allow the active component coating slurry to continuously pass through the channels of the support with regular structure.

The volume of the active component coating slurry passing through the channels of the support with regular structure can be 2-20 times the volume of the support with regular structure, and the applied vacuum pressure can be −0.1 MPa to −0.01 MPa. The coating temperature can be 10-70° C., and the coating time can be 0.1-300 seconds. The support with regular structure that has been coated with the active component coating slurry can be dried and calcined to produce a partial-active component coating distributed on the inner surface and/or the outer surface of the support with regular structure, i.e. to obtain a semi-finished catalyst product. that the semi-finished catalyst product obtained at this stage does not include the precious metal active component, so it is recorded as partial-active component coating. After the impregnation in step (5) is completed, the obtained material is then dried and/or calcined to produce an active component coating distributed on the inner surface and/or the outer surface of the support with regular structure.

According to the present invention, in step (5), the substance obtained after impregnation can be only dried, or only calcined, or dried and then calcined, and the present invention has no special limitation thereto. Preferably, the substance obtained after impregnation is dried and then calcined. The present invention has no special limitation on the condition for calcining in step (5). The calcining can be carried out according to conventional technical means in the art. For example, the calcining in step (5) can be performed in an air or inert atmosphere (e.g. nitrogen). The present invention has no special limitation on the condition for calcining in step (5). Preferably the condition for calcining includes: the temperature is 300-700° C., the time is 0.1-5 h.

The drying conditions in step (2), step (4) and step (5) of the present invention are not particularly limited and the drying can be carried out according to conventional technical means in the art. For example, in step (2), step (4) and step (5), the conditions for drying can each independently include: the temperature is 60-200° C., the time is 2-10 h.

According to the present invention, in step (5), the impregnation is not particularly limited and can be carried out according to conventional technical means in the art. Those skilled in the art can obtain a catalyst with a special content of precious metal with impregnation. The impregnation of the present invention can be saturation impregnation or over-impregnation.

According to the present invention, preferably, in step (5), the precursor of precious metal component is hydrolyzed in an acid solution to provide the solution. Specifically, after the hydrolysis, the dilution (e.g. by adding water) or the concentration (e.g. by evaporation), and then the impregnation can be performed to provide a catalyst with a specific loading amount of the precious metal component.

Preferably, the acid is selected from water-soluble inorganic acids and/or organic acids, preferably at least one of hydrochloric acid, nitric acid, phosphoric acid, and acetic acid.

According to the present invention, preferably, the acid is used in such an amount that the pH value of the impregnation solution is less than 6.0, preferably less than 5.0. Adopting this preferred embodiment is more conducive to the uniform dispersion of active components and can improve the wear resistance of the finished catalyst.

In the present invention, the solid product can be obtained by filtering the mixture obtained after impregnation. The filtering can be carried out according to conventional technical means in the art.

The third aspect of the present invention provides a method for simultaneously reducing both SOx and NOx from catalytic cracking regeneration flue gas, which method comprises: contacting the catalytic cracking regeneration flue gas with a catalyst under a condition for removing SOx and NOx, wherein the catalyst is a catalyst with regular structure capable of simultaneously reducing the emission of SOx and NOx according to the first aspect of the present invention or a catalyst with regular structure capable of simultaneously reducing the emission of SOx and NOx prepared with the preparation method according to the second aspect. The catalyst provided by the invention is particularly suitable for the treatment of the catalytic cracking regeneration flue gas containing both SOx and NOx at the same time.

The present invention has a relatively wide selection range for the contents of SOx and NOx in the catalytic cracking regeneration flue gas, as long as it contains both SOx and NOx at the same time, it will be beneficial to the removal of both. Preferably, in the catalytic cracking regeneration flue gas, the SOx content is 0.001-0.5 vol %, the NOx content is 0.001-0.3 vol %; further preferably, in the catalytic cracking regeneration flue gas, the SOx content is 0.002-0.2 vol %, the NOx content is 0.002-0.2 vol %.

Preferably, in the flue gas, the ratio of the SOx content by volume to the NOx content by volume is 1-1.4:1, preferably 1-1.2:1. This preferred embodiment is more conducive to improving the removal efficiency of the two.

In the present invention, the catalytic cracking regeneration flue gas may also contain gases other than SOx and NOx, including but not limited to CO, CO₂, H₂O, and the like.

According to the method of the present invention, preferably, the condition for contacting includes: the temperature is 300-1000° C., the reaction pressure by gauge is 0-0.5 MPa, the volumetric hourly space velocity of the catalytic cracking regeneration flue gas is 200-20000 h⁻¹; further preferably, the temperature is 450-750° C., the reaction pressure by gauge is 0.05-0.3 MPa, the volumetric hourly space velocity of the catalytic cracking regeneration flue gas is 1000-10000 h⁻¹.

According to the method of the present invention, preferably, the contacting is carried out in a flue gas channel provided after a cyclone separator and/or after a CO incinerator.

In the complete regeneration process, the flue gas after the cyclone separator at the outlet of the regenerator has a high concentration of SOx and NOx and a relatively small amount of catalyst fine particles, a relatively high temperature is conducive to improving the reaction conversion rate, and a relatively small amount of particles are less likely to block the channels. Based on this, preferably, the contact between the complete regeneration flue gas and the catalyst is carried out in the flue gas passway provided after the cyclone separator to catalytically convert SOx and NOx at the same time. In the incomplete regeneration process, since the flue gas has a low content of excess oxygen surplus oxygen and a high concentration of CO, the flue gas at the outlet of the regenerator has a very low concentration of NOx, and a relatively high concentration of nitrogen-containing compounds in reduction state such as NH₃ and HCN. These nitrogen-containing compounds in reduction state flow downstream with the flue gas, and if fully oxidized in the CO incinerator used for energy recovery, NOx is generated. Based on this, preferably, the contact between the incomplete regeneration flue gas and the catalyst is carried out in the CO incinerator and/or the flue gas passway provided after the CO incinerator to simultaneously catalytically convert SOx and NOx.

The present invention has no special limitation on the CO incinerator, and various CO incinerators conventionally used in the art can be used, such as a vertical CO incinerator or a horizontal CO incinerator.

In the present invention, the cyclone separator is preferably a three-stage cyclone separator. Preferably, the catalyst with regular structure exists in the form of catalyst bed(s). According to the method of the present invention, the catalyst with regular structure can be arranged as a fixed catalyst bed in the flue gas passway(s) provided after the cyclone separator and/or after the CO incinerator. The flowing catalytic cracking regeneration flue gas can flow through the bed of the catalyst with regular structure, i.e., can flow through the channels in the support with regular structure and undergo the reaction at the active component coating distributed on the walls of the channels.

The present invention also provides the following technical solutions:

1. A catalyst with regular structure capable of simultaneously reducing the emission of SOx and NOx, the catalyst comprises a support with regular structure and an active component coating distributed on the inner surface and/or the outer surface of the support with regular structure, based on the total weight of the catalyst, the content of the active component coating is 1-50 wt %, the active component coating contains a matrix and an active metal component, wherein, based on the total weight of the active component coating, the content of the matrix is 10-90 wt %, the content of the active metal component is 10-90 wt %, the active metal component contains: 1) as oxide, 50-95 wt % of metal component(s) selected from Group rare earth and/or Group IIA; 2) as oxide, 5-50 wt % of non-precious metal component(s) selected from Groups VB, VIIB, VIII, IB, and IIB; 3) as element, 0.01-2 wt % of precious metal component.

2. The catalyst with regular structure according to any one of the preceding technical solutions, wherein,
based on the total weight of the catalyst, the content of the active component coating is 5-40 wt %;
and/or, based on the total weight of the active component coating, the content of the matrix is 40-90 wt %, the content of the active metal component is 10-60 wt %;
and/or, the active metal component contains: 1) as oxide, 60-90 wt % of metal component(s) selected from Group rare earth and/or Group IIA; 2) as oxide, 10-40 wt % of non-precious metal component(s) selected from Groups VB, VIIB, VIII, IB, and IIB; 3) as element, 0.02-1.5 wt % of precious metal component;
preferably,
based on the total weight of the catalyst, the content of the active component coating is 10-35 wt %;
and/or, based on the total weight of the active component coating, the content of the matrix is 50-80 wt %, the content of the active metal component is 20-50 wt %;
and/or, the active metal component contains: 1) as oxide, 65-85 wt % of metal component(s) selected from Group rare earth and/or Group IIA; 2) as oxide, 15-35 wt % of non-precious metal component(s) selected from Groups VB, VIIB, VIII, IB, and IIB; 3) as element, 0.03-1.2 wt % of precious metal component.

3. The catalyst with regular structure according to any one of the preceding technical solutions, wherein, the matrix is at least one of alumina, spinel, perovskite, silica-alumina, zeolite, kaolin, diatomaceous earth, and perlite, preferably at least one of alumina, spinel, and perovskite, further preferably alumina;
preferably, the support with regular structure is selected from monolithic supports with parallel channel structure open at both ends;
preferably, the cross-section of the support with regular structure has a hole density of 10-300 holes/square inch, and an opening rate of 20-80%;
preferably, said support with regular structure is at least one of cordierite honeycomb support, mullite honeycomb support, diamond honeycomb support, corundum honeycomb support, fused-zirconia-alumina honeycomb support, quartz honeycomb support, nepheline honeycomb support, feldspar honeycomb support, alumina honeycomb support and metal alloy honeycomb support.

4. The catalyst with regular structure according to any one of the preceding technical solutions, wherein,
the rare earth metal component is one or more of La, Ce, Pr and Nd, preferably La and/or Ce, more preferably La;
said Group IIA metal component is one or more of Be, Mg, Ca, Sr and Ba, preferably Mg;
said non-precious metal component(s) selected from Groups VB, VIIB, VIII, IB, and IIB is one or more of Mn, Fe, Co, Ni, Cu, Zn and V, preferably at least one of Co, Fe and Mn, further preferably Mn, and Co and/or Fe, further more preferably Mn and Co;
said precious metal component is one or more of Ru, Rh, Re, Pt, Pd, Ag, Ir and Au, preferably one or more of Pt, Pd and Rh, more preferably Pd.

5. The catalyst with regular structure according to any one of the preceding technical solutions, wherein, based on the total amount of said active metal components, as oxide, the ratio of the content of metal component(s) selected from Group rare earth and/or Group IIA to the content of non-precious metal component(s) selected from Groups VB, VIIB, VIII, IB, and IIB is 1-8, preferably 1.5-6, more preferably 2-4.

6. The catalyst with regular structure according to any one of the preceding technical solutions, wherein, the active metal component contains or consists of:
1a) as oxide, one or more metal components selected from Group rare earth; preferably, La;
1b) as oxide, one or more metal components selected from Group IIA, preferably, Mg;
2a) as oxide, one or more non-precious metal components selected from Groups VB, VIII, IB and IIB; preferably, Co;
2b) as oxide, one or more non-precious metal components selected from Group VIIB; preferably, Mn;
3) as element, one or more of Pt, Pd and Rh; preferably, Pd.

7. The catalyst with regular structure according to technical solution 6, wherein, on the basis
that the total amount of said active metal component is 100 wt %,
the content of 1a) is 30-80 wt %, e.g., 35-75 wt %, or 40-70 wt %,
the content of 1b) is 5-40 wt %, e.g., 10-30 wt %,
the content of 2a) is 5-40 wt %, e.g., 3-30 wt %, or 5-20 wt %,
the content of 2b) is 3-20 wt %, e.g., 5-15 wt %,
the content of c) is 0.01-0.2 wt %.

8. The catalyst with regular structure according to technical solution 6, wherein, the molar ratio of La:Co is (0.5-15): 1, e.g. (1-10): 1, or (1-6): 1, (2-5): 1, or (2.5-3.5): 1, or (2.6-3.4): 1, or (2.7-3.3): 1, or (2.8-3.2): 1, or (2.9-3.1): 1, or (2.95-3.05): 1.

9. The catalyst according to any one of the preceding technical solutions, wherein the catalyst has characteristic peaks at 2θ=33.0°±0.1°, 33.5°±0.1°, and 47.5°±0.1°, as well as 27.0°±0.1°, 28.0°±0.1°, and 39.5°±0.1° in the powder XRD spectrum.

10. The catalyst according to any one of the preceding technical solutions, wherein the catalyst is a catalyst that has been exposed to an atmosphere containing SO₂;
for example, the catalyst is a catalyst that has been exposed to an atmosphere containing SO₂, wherein the atmosphere containing SO₂ has a temperature of 350-1000° C., a pressure of 0-8 MPa, and an SO₂ content of 0.001-100 vol %; or
the catalyst is a catalyst that has been exposed to an atmosphere containing SO₂ for at least 1 minute, wherein the atmosphere containing SO₂ has a temperature of 400-900° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 450-900° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 500-900° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 550-900° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 600-900° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 650-900° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 400-800° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 450-800° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 500-800° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 550-800° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 600-900° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 650-900° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 400-750° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 450-750° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 500-750° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 550-750° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 600-750° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 650-750° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 400-700° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 450-700° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 500-700° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 550-700° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 600-700° C., a pressure of 0-5 MPa, and an SO₂ content of 0.001-5 vol %; or
the catalyst is a catalyst that has been exposed to an atmosphere containing SO₂ for at least 1 minute, wherein the atmosphere containing SO₂ has a temperature of 650-700° C., a pressure of 0-5 MPa, and an SO₂ content of 0.001-5 vol %; or
the catalyst is a catalyst that has been exposed to an atmosphere containing SO₂ for 30-480 minutes, wherein the atmosphere containing SO₂ has a temperature of 400-900° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 450-900° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 500-900° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 550-900° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 600-900° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 650-900° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 400-800° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 450-800° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 500-800° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 550-800° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 600-800° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 650-800° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 400-750° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 450-750° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 500-750° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 550-750° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 600-750° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 650-750° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 400-700° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 450-700° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 500-700° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 550-700° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 600-700° C., a pressure of 0-2 MPa, and an SO₂ content of 0.01-1 vol %; or
the catalyst is a catalyst that has been exposed to an atmosphere containing SO₂ for 30-480 minutes, wherein the atmosphere containing SO₂ has a temperature of 650-700° C., a pressure of 0-2 MPa, and an SO₂ content of 0.01-1 vol %; or
the catalyst is a catalyst that has been exposed to an atmosphere containing SO₂ for 60-120 minutes, wherein the atmosphere containing SO₂ has a temperature of 400-900° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 450-900° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 500-900° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 550-900° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 600-900° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 650-900° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 400-800° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 450-800° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 500-800° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 550-800° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 600-800° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 650-800° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 400-750° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 450-750° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 500-750° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 550-750° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 600-750° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 650-750° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 650-750° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 400-700° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 450-700° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 500-700° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 550-700° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 600-700° C., a pressure of 0-0.5 MPa, and an SO₂ content of 0.02-0.5 vol %; or
the catalyst is a catalyst that has been exposed to an atmosphere containing SO₂ for 60-120 minutes, wherein the atmosphere containing SO₂ has a temperature of 650-700° C., the pressure is 0-0.5 MPa, and an SO₂ content of 0.02-0.5 vol %.

11. The catalyst according to any one of the preceding technical solutions, wherein the catalyst is a catalyst that has been exposed to an atmosphere containing SO₂, the catalyst has characteristic peaks at 2θ=28.6°±0.1°, 30.0°±0.1° and 50.4°±0.1° in the powder XRD spectrum.

12. A method for preparing a catalyst with regular structure capable of simultaneously reducing the emission of SOx and NOx, which method comprises the steps of:
(1) formulating a solution containing a precursor of metal component(s) selected from Group rare earth and/or Group IIA and a precursor of non-precious metal component(s) selected from Groups VB, VIIB, VIII, IB, and IIB;
(2) carrying out a coprecipitation reaction between the solution obtained in step (1) and a coprecipitant, and then drying and calcining the obtained solid product to obtain an active metal component precursor;
(3) mixing and slurrifying the active metal component precursor, a matrix source and water to produce an active component coating slurry;
(4) coating the support with regular structure with the active component coating slurry and drying and calcining to produce a partial-active component coating distributed on the inner surface and/or the outer surface of the support with regular structure, i.e. to obtain a semi-finished catalyst product;
(5) impregnating the semi-finished catalyst product obtained in step (4) with a solution containing a precursor of precious metal component, then drying and/or calcining to produce an active component coating distributed on the inner surface and/or the outer surface of the support with regular structure;
wherein the precursor of metal component(s) selected from Group rare earth and/or Group IIA, the precursor of non-precious metal component(s) selected from Groups VB, VIIB, VIII, IB, and IIB, the matrix source, the precursor of precious metal component, and the support with regular structure are used in such amounts that in the prepared catalyst with regular structure, based on the total weight of the catalyst, the content of the active component coating is 1-50 wt %, the active component coating contains a matrix and an active metal component, wherein, based on the total weight of the active component coating, the content of the matrix is 10-90 wt %, the content of the active metal component is 10-90 wt %, the active metal component contains: 1) as oxide, 50-95 wt % of metal component(s) selected from Group rare earth and/or Group IIA; 2) as oxide, 5-50 wt % of non-precious metal component(s) selected from Groups VB, VIIB, VIII, IB, and IIB; 3) as element, 0.01-2 wt % of precious metal component.

13. The preparation method according to any of the preceding technical solutions, wherein the precursor of metal component(s) selected from Group rare earth and/or Group IIA, the precursor of non-precious metal component(s) selected from Groups VB, VIIB, VIII, IB, and IIB, the matrix source, the precursor of precious metal component, and the support with regular structure are used in such amounts that in the prepared catalyst with regular structure, based on the total weight of the catalyst, the content of the active component coating is 5-40 wt %, the active component coating contains a matrix and an active metal component, wherein, based on the total weight of the active component coating, the content of the matrix is 40-90 wt %, the content of the active metal component is 10-60 wt %, the active metal component contains: 1) as oxide, 60-90 wt % of metal component(s) selected from Group rare earth and/or Group IIA; 2) as oxide, 10-40 wt % of non-precious metal component(s) selected from Groups VB, VIIB, VIII, IB, and IIB; 3) as element, 0.02-1.5 wt % of precious metal component;
preferably, the precursor of metal component(s) selected from Group rare earth and/or Group IIA, the precursor of non-precious metal component(s) selected from Groups VB, VIIB, VIII, IB, and IIB, the matrix source, the precursor of precious metal component, and the support with regular structure are used in such amounts that in the prepared catalyst with regular structure, based on the total weight of the catalyst, the content of the active component coating is 10-35 wt %, the active component coating contains a matrix and an active metal component, wherein, based on the total weight of the active component coating, the content of the matrix is 50-80 wt %, the content of the active metal component is 20-50 wt %, the active metal component contains: 1) as oxide, 65-85 wt % of metal component(s) selected from Group rare earth and/or Group IIA; 2) as oxide, 15-35 wt % of non-precious metal component(s) selected from Groups VB, VIIB, VIII, IB, and IIB; 3) as element, 0.03-1.2 wt % of precious metal component.

14. The preparation method according to any of the preceding technical solutions, wherein the precursor of metal component(s) selected from Group rare earth and/or Group IIA, the precursor of non-precious metal component(s) selected from Groups VB, VIIB, VIII, IB, and IIB, the matrix source, the precursor of precious metal component, and the support with regular structure are used in such amounts that in the prepared catalyst with regular structure, based on the total amount of said active metal components, as oxide, the ratio of the content of metal component(s) selected from Group rare earth and/or Group IIA to the content of non-precious metal component(s) selected from Groups VB, VIIB, VIII, IB, and IIB is 1-8, preferably 1.5-6, more preferably 2-4.

15. The preparation method according to any of the preceding technical solutions, wherein the precursor of metal component(s) selected from Group rare earth and/or Group IIA, the precursor of non-precious metal component(s) selected from Groups VB, VIIB, VIII, IB, and IIB, the matrix source, the precursor of precious metal component, and the support with regular structure are used in such amounts that in the prepared catalyst with regular structure, the active metal component contains or consists of:
1a) as oxide, one or more metal components selected from Group rare earth; preferably, La;
1b) as oxide, one or more metal components selected from Group IIA, preferably, Mg;
2a) as oxide, one or more non-precious metal components selected from Groups VB, VIII, IB and IIB; preferably, Co;
2b) as oxide, one or more non-precious metal components selected from Group VIIB; preferably, Mn;
3) as element, one or more of Pt, Pd and Rh; preferably, Pd;
preferably, on the basis that the total amount of said active metal component is 100 wt %,
the content of 1a) is 30-80 wt %, e.g., 35-75 wt %, or 40-70 wt %,
the content of 1b) is 5-40 wt %, e.g., 10-30 wt %,
the content of 2a) is 5-40 wt %, e.g., 3-30 wt %, or 5-20 wt %,
the content of 2b) is 3-20 wt %, e.g., 5-15 wt %,
the content of c) is 0.01-0.2 wt %; and/or
preferably, the molar ratio of La:Co is (0.5-15): 1, e.g. (1-10): 1, or (1-6): 1, (2-5): 1, or (2.5-3.5): 1, or (2.6-3.4): 1, or (2.7-3.3): 1, or (2.8-3.2): 1, or (2.9-3.1): 1, or (2.95-3.05): 1.

16. The preparation method according to any of the preceding technical solutions, wherein the matrix source is a substance that can be transformed into the matrix under calcining in step (4); the matrix is at least one of alumina, spinel, perovskite, silica-alumina, zeolite, kaolin, diatomaceous earth, and perlite, preferably at least one of alumina, spinel, and perovskite, further preferably alumina;
preferably, the support with regular structure is selected from monolithic supports with parallel channel structure open at both ends;
preferably, the cross-section of the support with regular structure has a hole density of 10-300 holes/square inch, and an opening rate of 20-80%;
preferably, said support with regular structure is at least one of cordierite honeycomb support, mullite honeycomb support, diamond honeycomb support, corundum honeycomb support, fused-zirconia-alumina honeycomb support, quartz honeycomb support, nepheline honeycomb support, feldspar honeycomb support, alumina honeycomb support and metal alloy honeycomb support.

17. The preparation method according to any of the preceding technical solutions, wherein the rare earth metal component is one or more of La, Ce, Pr and Nd, preferably La and/or Ce, more preferably La;
said Group IIA metal component is one or more of Be, Mg, Ca, Sr and Ba, preferably Mg;
said non-precious metal component(s) selected from Groups VB, VIIB, VIII, IB, and IIB is one or more of Mn, Fe, Co, Ni, Cu, Zn and V, preferably at least one of Co, Fe and Mn, more preferably Mn, and Co and/or Fe, further more preferably Mn and Co;
said precious metal component is one or more of Ru, Rh, Re, Pt, Pd, Ag, Ir and Au, preferably one or more of Pt, Pd and Rh, more preferably Pd.

18. The preparation method according to any of the preceding technical solutions, wherein the precursor of metal component(s) selected from Group rare earth and/or Group IIA and the precursor of non-precious metal component(s) selected from Groups VB, VIIB, VIII, IB, and IIB are each independently selected from nitrate and/or chloride of each metal component;
preferably, the coprecipitant is a carbonate salt, further preferably at least one of ammonium carbonate, potassium carbonate and sodium carbonate;
preferably, the coprecipitation reaction is carried out at pH=8-10;
preferably, the condition for calcining in step (2) includes: the temperature is 300-800° C., the time is 1-8 h.

19. The preparation method according to any of the preceding technical solutions, wherein the active component coating slurry in step (3) has a solid content of 5-45 wt %;
preferably, the condition for calcining in step (4) includes: the temperature is 300-800° C., the time is 1-5 h;
preferably, in step (5), the precursor of precious metal component is hydrolyzed in an acid solution to provide the solution;
preferably, the acid is selected from water-soluble inorganic acids and/or organic acids, preferably at least one of hydrochloric acid, nitric acid, phosphoric acid, and acetic acid;
preferably, the acid is used in such an amount that the pH value of the impregnation solution is less than 6.0, preferably less than 5.0;
preferably, the condition for calcining in step (5) includes: the temperature is 300-700° C., the time is 0.1-5 h.

20. A method for simultaneously reducing both SOx and NOx from catalytic cracking regeneration flue gas, which method comprises: contacting the catalytic cracking regeneration flue gas with a catalyst under a condition for removing SOx and NOx, the catalyst is a catalyst with regular structure capable of simultaneously reducing the emission of SOx and NOx according to any one of the preceding technical solutions or a catalyst with regular structure capable of simultaneously reducing the emission of SOx and NOx prepared with the preparation method according to any one of the preceding technical solutions;
preferably, the contact between the catalytic cracking regeneration flue gas and the catalyst with regular structure is performed in a flue gas passway provided after a catalytic cracking cyclone separator and/or after a CO incinerator;
preferably, the condition for contacting includes: the temperature is 300-1000° C., e.g. 500-800° C., or 600-750° C., or 625-750° C., or 650-750° C., or 675-750° C., or 700-750° C., or 725-750° C., or 600-725° C., or 625-725° C., or 650-725° C., or 675-725° C., or 700-725° C., or 600-700° C., or 625-700° C., or 650-700° C., or 675-700° C., or 600-675° C., or 625-675° C., or 650-675° C., or 600-650° C., or 625-650° C., or 600-625° C., the reaction pressure by gauge is 0-4 MPa, e.g. 0.01-4 MPa, or 0.02-4 MPa, or 0-0.5 MPa; the volumetric hourly space velocity of the catalytic cracking regeneration flue gas is 100-50000 h⁻¹ or 200-20000 h⁻¹, 500-10000 h⁻¹, 1000-5000 h⁻¹, e.g., the volumetric hourly space velocity of the catalytic cracking regeneration flue gas is 200-20000 h⁻¹.

21. A method for simultaneously reducing both SOx and NOx from flue gas, which method comprises, under a condition for removing SOx and NOx, contacting the flue gas with a catalyst, the catalyst is a catalyst according to any one of the preceding technical solutions or a catalyst prepared by a preparation method according to any one of the preceding technical solutions; preferably, the flue gas is a flue gas containing a certain concentration of SOx and NOx at the same time, including but not limited to a catalytic cracking regeneration flue gas;
preferably, the volume fractions of SOx and NOx in the flue gas are respectively 1-3000 μL/L, the molar ratio of SOx to NOx is 0.5:1-2:1;
preferably, the condition for contacting includes: the temperature is 300-1000° C., e.g. 500-800° C., or 600-750° C., or 625-750° C., or 650-750° C., or 675-750° C., or 700-750° C., or 725-750° C., or 600-725° C., or 625-725° C., or 650-725° C., or 675-725° C., or 700-725° C., or 600-700° C., or 625-700° C., or 650-700° C., or 675-700° C., or 600-675° C., or 625-675° C., or 650-675° C., or 600-650° C., or 625-650° C., or 600-625° C., the reaction pressure by gauge is 0-4 MPa, e.g. 0.01-4 MPa, or 0.02-4 MPa, or 0-0.5 MPa; the volumetric hourly space velocity of flue gas is 100-50000 h⁻¹ or 200-20000 h⁻¹, 500-10000 h⁻¹, 1000-5000 h⁻¹, e.g., the volumetric hourly space velocity of the catalytic cracking regeneration flue gas is 200-20000 h⁻¹.

In the present invention, the condition for calcining is not particularly limited. For example, the calcining can be performed in an air or inert atmosphere (e.g. nitrogen); the condition for calcining may be: the temperature is 300-900° C., e.g. 400, 500, 600, 700, 800° C. and a temperature range formed from any two of these points, the time is 0.1-12 h, e.g. 0.1-5 h, and the pressure can be below atmospheric pressure, atmospheric pressure, or above atmospheric pressure (e.g. 0-5 MPa).

In the present invention, the condition for drying is not particularly limited. For example, the condition for drying may be: the temperature is 25-250° C., the time is 0.1-12 h, and the pressure may be in vacuum (for example the absolute pressure is 0-1 kPa, 0-5 kPa, 0-10 kPa, 0-20 kPa, 0-30 kPa, 0-40 kPa, 0-50 kPa, 0-60 kPa, 0-70 kPa, 0-80 kPa, 0-90 kPa, 0-100 kPa) or atmospheric pressure (the absolute pressure is 0.1 MPa). In the present invention, in case that the dying followed by the calcining is performed, the drying temperature is lower than the calcining temperature.

In the present invention, the ppm refers to the volume concentration unless otherwise specified. In the present invention, SOx refers to a mixture of sulfur oxides (e.g. a mixture of SO₂ and SO₃, the molar ratio of oxides is not particularly limited, e.g. 1:10 to 10:1), NOx refers to a mixture of nitrogen oxides (e.g. a mixture of NO2 and NO, the molar ratio of oxides is not particularly limited, e.g. 1:10 to 10:1).

The present inventors discovered during the research that using specific amounts of rare earth metal element(s) (e.g. La) and Group VIII non-precious metal(s) (e.g. Co) in combination with at least one precious metal element (such as Pt) as active components with a specific ratio of rare earth metal(s) to Group VIII non-noble metal(s) can effectively reduce the emissions of SOx and NOx in flue gas at the same time. On this basis, the introduction of Group IIA metal components (e.g. Mg) and/or the introduction of Group VIIB metal components (e.g. Mn) can further improve the ability of the catalyst to remove NOx and SOx in combination. When contacting the catalyst of the present invention with SO₂, it is believed that the sulfur element can be converted into different valence states, in which the low-valence sulfur element is beneficial to the conversion of NOx in the flue gas, so that the entire process can promote the conversion of SOx and NOx in a direction that is conducive to reducing the pollution.

The present invention will be described in detail with examples below. In the following examples, the contents of the components are determined by X-ray fluorescence spectroscopy (XRF). The used raw materials include lanthanum nitrate (analytically pure, Aladdin Biochemical Company), magnesium nitrate (analytically pure, Sinopharm Chemical Reagent Co., Ltd.), manganese chloride (analytically pure, Beijing Chemical Plant), cobalt nitrate (analytically pure, Beijing Inno-Chem Technology Co., Ltd.), ammonium carbonate (analytically pure, Beijing Chemical Plant), ammonia water (analytically pure, 25%, Damao Chemical Reagent Factory), palladium chloride (Sinopharm Beijing Subsidiary-Procurement Supply Station), hydrochloric acid (Beijing Chemical Plant), OX50-SiO₂ (Sinopec Catalyst Company).

In the following examples, the contents of the components in a catalyst are determined by X-ray fluorescence spectroscopy (XRF). For details, see Petrochemical Analysis Methods (RIPP Experimental Methods), edited by Yang Cuiding et al., published by Science Press in 1990. In the following examples, a Siemens D5005 diffractometer was used to perform powder X-ray diffraction (XRD) analysis on the catalyst sample, in which CuKa (λ=0.15418 nm) radiation was generated under the conditions of 40 kV, 40 mA and filtered by Ni. Diffraction signals were recorded in the range of 2θ 5-70° with a step of 0.02°.

### Example 1

320 mL of deionized water was added to a beaker, and then 20 g as the mass of La₂O₃ of lanthanum nitrate, 4 g as the mass of MgO of magnesium nitrate, 5 g as the mass of CO₂O₃ of cobalt nitrate and 3 g as the mass of MnO of manganese chloride were added under stirring until completely dissolved to produce a solution of a precursor of non-precious metal component. Ammonium carbonate (48 g) was added to deionized water (200 mL), and the mixture was stirred until completely dissolved. The metal nitrate mixed solution was added to the ammonium carbonate solution while stirring, and a certain amount of ammonia water was added to maintain the pH value of the solution at 9.

The completely precipitated mixture was suction-filtered and rinsed with deionized water. The filter cake mixture obtained by suction filtering was dried at 120° C., calcined at 700° C. in an air atmosphere for 5 hours, and then ground to obtain an active metal component precursor.

30 g as the mass of Al₂O₃ of bauxite was weighed, and 160 mL of water and 4.5 g of concentrated hydrochloric acid (36 wt %) were added. The resulting mixture was slurrified. 20 g of the active metal precursor was weighed and added to the acidified inorganic oxide matrix and the resulting mixture was stirred to produce an active component coating slurry.

The above-obtained active component coating slurry was coated to 300 g of cordierite support with regular structure (200 holes/square inch), and then dried and calcined to produce an active component coating distributed on the inner surface and/or the outer surface of the support with regular structure, and the obtained component was dried at 120° C. and calcined in an air atmosphere at 700° C. for 4 hours to produce a semi-finished product of the catalyst with regular structure.

A precursor of Pd was dissolved in a diluted hydrochloric acid at a mass ratio of 1:1, and the resulting mixture was diluted with deionized water to produce a palladium chloride solution. A certain amount (the Pd equivalent mass of 0.009 g) of the palladium chloride solution was taken. The Pd-containing solution as impregnation solution was impregnated to the above-mentioned semi-finished catalyst product to produce a solid product, then the solid product was dried at 120° C., and calcined in an air atmosphere at 600° C. for 4 hours to produce catalyst S-1, wherein based on the total weight of the catalyst with regular structure, the content of the active component coating was 14.3 wt %.

A part of the active component coating was taken and the XRD analysis was performed thereon. In the XRD spectrum, there were characteristic peaks at 2θ=about 33.0°, about 33.5° and about 47.5° as well as at 2θ=about 27.0°, about 28.0° and about 39.5°;

A part of the active component coating was taken and exposed to an atmosphere containing SO₂ for 1 minute, wherein the atmosphere containing SO₂ had a temperature of 800° C., a pressure of 0 MPa, and an SO₂ content of 0.001 vol %. After exposure to SO₂ treatment, XRD analysis was performed on the coating. In the XRD spectrum, there were characteristic peaks at 2θ=about 28.6°, about 30.0° and about 50.4°.

### Example 2

250 mL of deionized water was added to a beaker, and then 10 g as the mass of La₂O₃ of lanthanum nitrate, 7 g as the mass of MgO of magnesium nitrate, 5 g as the mass of CO₂O₃ of cobalt nitrate and 3 g as the mass of MnO of manganese chloride were added under stirring until completely dissolved to produce a solution of a precursor of non-precious metal component. Ammonium carbonate (38 g) was added to deionized water (150 mL), and the mixture was stirred until completely dissolved. The metal nitrate mixed solution was added to the ammonium carbonate solution while stirring, and a certain amount of ammonia water was added to maintain the pH value of the solution at 9.

The completely precipitated mixture was suction-filtered and rinsed with deionized water. The filter cake mixture obtained by suction filtering was dried at 120° C., calcined at 700° C. in an air atmosphere for 5 hours, and then ground to obtain an active metal component precursor. 40 g as the mass of Al₂O₃ of bauxite was weighed, and 180 mL of water and 6 g of concentrated hydrochloric acid (36 wt %) were added. The resulting mixture was slurrified. 10 g of the active metal precursor was weighed and added to the acidified inorganic oxide matrix and the resulting mixture was stirred to produce an active component coating slurry.

The above-obtained active component coating slurry was coated to 300 g of cordierite support with regular structure (200 holes/square inch), and then dried and calcined to produce an active component coating distributed on the inner surface and/or the outer surface of the support with regular structure, and the obtained component was dried at 120° C. and calcined in an air atmosphere at 700° C. for 4 hours to produce a semi-finished product of the catalyst with regular structure.

A precursor of Pd was dissolved in a diluted hydrochloric acid at a mass ratio of 1:1, and the resulting mixture was diluted with deionized water to produce a palladium chloride solution. A certain amount (the Pd equivalent mass of 0.018 g) of the palladium chloride solution was taken. The Pd-containing solution as impregnation solution was impregnated to the above-mentioned semi-finished catalyst product to produce a solid product, then the solid product was dried at 120° C., and calcined in an air atmosphere at 600° C. for 4 hours to produce catalyst S-2, wherein based on the total weight of the catalyst with regular structure, the content of the active component coating was 14.3 wt %.

A part of the active component coating was taken and the XRD analysis was performed thereon. In the XRD spectrum, there were characteristic peaks at 2θ=about 33.0°, about 33.5° and about 47.5° as well as at 20=about 27.0°, about 28.0° and about 39.5°;

A part of the active component coating was taken and exposed to an atmosphere containing SO₂ for 5 minutes, wherein the atmosphere containing SO₂ had a temperature of 700° C., a pressure of 0.1 MPa, and an SO₂ content of 0.01 vol %. After exposure to SO₂ treatment, XRD analysis was performed on the coating. In the XRD spectrum, there were characteristic peaks at 20=about 28.6°, about 30.0° and about 50.4°.

### Example 3

360 mL of deionized water was added to a beaker, and then 25 g as the mass of La₂O₃ of lanthanum nitrate, 5 g as the mass of MgO of magnesium nitrate, 2.6 g as the mass of CO₂O₃ of cobalt nitrate and 3.4 g as the mass of MnO of manganese chloride were added under stirring until completely dissolved to produce a solution of a precursor of non-precious metal component. Ammonium carbonate (54 g) was added to deionized water (210 mL), and the mixture was stirred until completely dissolved. The metal nitrate mixed solution was added to the ammonium carbonate solution while stirring, and a certain amount of ammonia water was added to maintain the pH value of the solution at 9.

The completely precipitated mixture was suction-filtered and rinsed with deionized water. The filter cake mixture obtained by suction filtering was dried at 120° C., calcined at 700° C. in an air atmosphere for 5 hours, and then ground to obtain an active metal component precursor. 20 g as the mass of Al₂O₃ of bauxite was weighed, and 120 mL of water and 3 g of concentrated hydrochloric acid (36 wt %) were added. The resulting mixture was slurrified. 20 g of the active metal precursor was weighed and added to the acidified inorganic oxide matrix and the resulting mixture was stirred to produce an active component coating slurry.

The above-obtained active component coating slurry was coated to 300 g of cordierite support with regular structure (200 holes/square inch), and then dried and calcined to produce an active component coating distributed on the inner surface and/or the outer surface of the support with regular structure, and the obtained component was dried at 120° C. and calcined in an air atmosphere at 700° C. for 4 hours to produce a semi-finished product of the catalyst with regular structure.

A precursor of Pd was dissolved in a diluted hydrochloric acid at a mass ratio of 1:1, and the resulting mixture was diluted with deionized water to produce a palladium chloride solution. A certain amount (the Pd equivalent mass of 0.004 g) of the palladium chloride solution was taken. The Pd-containing solution as impregnation solution was impregnated to the above-mentioned semi-finished catalyst product to produce a solid product, then the solid product was dried at 120° C., and calcined in an air atmosphere at 600° C. for 4 hours to produce catalyst S-3, wherein based on the total weight of the catalyst with regular structure, the content of the active component coating was 11.8 wt %.

A part of the active component coating was taken and the XRD analysis was performed thereon. In the XRD spectrum, there were characteristic peaks at 2θ=about 33.0°, about 33.5° and about 47.5° as well as at 2θ=about 27.0°, about 28.0° and about 39.5°;

A part of the active component coating was taken and exposed to an atmosphere containing SO₂ for 15 minutes, wherein the atmosphere containing SO₂ had a temperature of 650° C., a pressure of 0 MPa, and an SO₂ content of 0.001 vol %. After exposure to SO₂ treatment, XRD analysis was performed on the coating. In the XRD spectrum, there were characteristic peaks at 20=about 28.6°, about 30.0° and about 50.4°.

### Example 4

310 mL of deionized water was added to a beaker, and then 12 g as the mass of La₂O₃ of lanthanum nitrate, 4 g as the mass of MgO of magnesium nitrate, 12 g as the mass of CO₂O₃ of cobalt nitrate and 3 g as the mass of MnO of manganese chloride were added under stirring until completely dissolved to produce a solution of a precursor of non-precious metal component. Ammonium carbonate (47 g) was added to deionized water (200 mL), and the mixture was stirred until completely dissolved. The metal nitrate mixed solution was added to the ammonium carbonate solution while stirring, and a certain amount of ammonia water was added to maintain the pH value of the solution at 9.

The completely precipitated mixture was suction-filtered and rinsed with deionized water. The filter cake mixture obtained by suction filtering was dried at 120° C., calcined at 700° C. in an air atmosphere for 5 hours, and then ground to obtain an active metal component precursor.

30 g as the mass of Al₂O₃ of bauxite was weighed, and 160 mL of water and 4.5 g of concentrated hydrochloric acid (36 wt %) were added. The resulting mixture was slurrified. 20 g of the active metal precursor was weighed and added to the acidified inorganic oxide matrix and the resulting mixture was stirred to produce an active component coating slurry.

The above-obtained active component coating slurry was coated to 300 g of cordierite support with regular structure (200 holes/square inch), and then dried and calcined to produce an active component coating distributed on the inner surface and/or the outer surface of the support with regular structure, and the obtained component was dried at 120° C. and calcined in an air atmosphere at 700° C. for 4 hours to produce a semi-finished product of the catalyst with regular structure.

A precursor of Pd was dissolved in a diluted hydrochloric acid at a mass ratio of 1:1, and the resulting mixture was diluted with deionized water to produce a palladium chloride solution. A certain amount (the Pd equivalent mass of 0.009 g) of the palladium chloride solution was taken. The Pd-containing solution as impregnation solution was impregnated to the above-mentioned semi-finished catalyst product to produce a solid product, then the solid product was dried at 120° C., and calcined in an air atmosphere at 600° C. for 4 hours to produce catalyst S-4, wherein based on the total weight of the catalyst with regular structure, the content of the active component coating was 14.3 wt %.

A part of the active component coating was taken and the XRD analysis was performed thereon. In the XRD spectrum, there were characteristic peaks at 2θ=about 33.0°, about 33.5° and about 47.5° as well as at 2θ=about 27.0°, about 28.0° and about 39.5°;

A part of the active component coating was taken and exposed to an atmosphere containing SO₂ for 30 minutes, wherein the atmosphere containing SO₂ had a temperature of 675° C., a pressure of 0.2 MPa, and an SO₂ content of 0.001 vol %. After exposure to SO₂ treatment, XRD analysis was performed on the coating. In the XRD spectrum, there were characteristic peaks at 2θ=about 28.6°, about 30.0° and about 50.4°.

### Example 5

320 mL of deionized water was added to a beaker, and then 20 g as the mass of La₂O₃ of lanthanum nitrate, 4 g as the mass of MgO of magnesium nitrate, 5 g as the mass of CO₂O₃ of cobalt nitrate and 3 g as the mass of MnO of manganese chloride were added under stirring until completely dissolved to produce a solution of a precursor of non-precious metal component. Ammonium carbonate (48 g) was added to deionized water (200 mL), and the mixture was stirred until completely dissolved. The metal nitrate mixed solution was added to the ammonium carbonate solution while stirring, and a certain amount of ammonia water was added to maintain the pH value of the solution at 9.

The completely precipitated mixture was suction-filtered and rinsed with deionized water. The filter cake mixture obtained by suction filtering was dried at 120° C., calcined at 700° C. in an air atmosphere for 5 hours, and then ground to obtain an active metal component precursor. 30 g as the mass of Al₂O₃ of bauxite was weighed, and 160 mL of water and 4.5 g of concentrated hydrochloric acid (36 wt %) were added. The resulting mixture was slurrified. 20 g of the active metal precursor was weighed and added to the acidified inorganic oxide matrix and the resulting mixture was stirred to produce an active component coating slurry.

The above-obtained active component coating slurry was coated to 300 g of cordierite support with regular structure (200 holes/square inch), and then dried and calcined to produce an active component coating distributed on the inner surface and/or the outer surface of the support with regular structure, and the obtained component was dried at 120° C. and calcined in an air atmosphere at 700° C. for 4 hours to produce a semi-finished product of the catalyst with regular structure.

A precursor of Ru was dissolved in a diluted hydrochloric acid at a mass ratio of 1:1, and the resulting mixture was diluted with deionized water to produce a ruthenium chloride solution. a certain amount (the Ru equivalent mass of 0.009 g) of the ruthenium chloride solution was taken. The Ru-containing solution as impregnation solution was impregnated to the above-mentioned semi-finished catalyst product to produce a solid product, then the solid product was dried at 120° C., and calcined in an air atmosphere at 600° C. for 4 hours to produce catalyst S-5, wherein based on the total weight of the catalyst with regular structure, the content of the active component coating was 14.3 wt %.

### Example 6

320 mL of deionized water was added to a beaker, and then 20 g as the mass of CeO₂ of cerium nitrate, 4 g as the mass of MgO of magnesium nitrate, 5 g as the mass of Fe₂O₃ of ferric nitrate and 3 g as the mass of MnO of manganese chloride were added under stirring until completely dissolved to produce a solution of a precursor of non-precious metal component. Ammonium carbonate (48 g) was added to deionized water (200 mL), and the mixture was stirred until completely dissolved. The metal nitrate mixed solution was added to the ammonium carbonate solution while stirring, and a certain amount of ammonia water was added to maintain the pH value of the solution at 9.

The completely precipitated mixture was suction-filtered and rinsed with deionized water. The filter cake mixture obtained by suction filtering was dried at 120° C., calcined at 700° C. in an air atmosphere for 5 hours, and then ground to obtain an active metal component precursor. 30 g as the mass of Al₂O₃ of bauxite was weighed, and 160 ml of water and 4.5 g of concentrated hydrochloric acid (36 wt %) were added. The resulting mixture was slurrified. 20 g of the active metal precursor was weighed and added to the acidified inorganic oxide matrix and the resulting mixture was stirred to produce an active component coating slurry.

The above-obtained active component coating slurry was coated to 300 g of cordierite support with regular structure (200 holes/square inch), and then dried and calcined to produce an active component coating distributed on the inner surface and/or the outer surface of the support with regular structure, and the obtained component was dried at 120° C. and calcined in an air atmosphere at 700° C. for 4 hours to produce a semi-finished product of the catalyst with regular structure.

A precursor of Pd was dissolved in a diluted hydrochloric acid at a mass ratio of 1:1, and the resulting mixture was diluted with deionized water to produce a palladium chloride solution. A certain amount (the Pd equivalent mass of 0.009 g) of the palladium chloride solution was taken. The Pd-containing solution as impregnation solution was impregnated to the above-mentioned semi-finished catalyst product to produce a solid product, then the solid product was dried at 120° C., and calcined in an air atmosphere at 600° C. for 4 hours to produce catalyst S-6, wherein based on the total weight of the catalyst with regular structure, the content of the active component coating was 14.3 wt %.

### Comparative Example 1

20 g of La₂O₃ and 5 g of CO₂O₃ were fully and mechanically mixed to obtain a mixed precursor.

30 g as the mass of Al₂O₃ of bauxite was weighed, and 380 mL of water and 4.5 g of concentrated hydrochloric acid (36 wt %) were added. The resulting mixture was slurrified. 20 g of the mixed precursor was weighed and added to the acidified inorganic oxide matrix and the resulting mixture was stirred to produce an active component coating slurry.

The above-obtained active component coating slurry was coated to 300 g of cordierite support with regular structure (200 holes/square inch), and then dried and calcined to produce an active component coating distributed on the inner surface and/or the outer surface of the support with regular structure, and the obtained component was dried at 120° C. and calcined in an air atmosphere at 700° C. for 4 hours to produce catalyst D-1, wherein based on the total weight of the catalyst with regular structure, the content of the active component coating was 14.3 wt %.

The compositions of the above-obtained catalysts are listed in Table 1.

TABLE 1
Compositions of catalysts (wt %)

| | Rare earth | | Group VIIB | Group VB, VIII, | |
|---|---|---|---|---|---|
| | group | Group IIA | non-precious | IB, IIB non- | Precious |
| Ex. | metal | metal | metal | precious metal | metal |
| 1 | 25 | 5 | 3.8 | 6.2 | 0.018 |
| 2 | 8 | 5.6 | 2.4 | 4 | 0.036 |
| 3 | 34.7 | 6.9 | 4.7 | 3.6 | 0.010 |
| 4 | 15.5 | 5.2 | 3.8 | 15.5 | 0.018 |
| 5 | 25 | 5 | 3.8 | 6.2 | 0.018 |
| 6 | 25 | 5 | 3.8 | 6.2 | 0.018 |

Note:
The contents of components in Table 1 are based on the total amount of the active component coating.

### Test Example 1

This test was used to evaluate the catalysts provided in the above examples and comparative examples for their effects in simultaneously reducing the emissions of both NO and SO₂ in flue gas. The catalytic cracking reaction-regeneration evaluation was carried out on a small fixed-bed simulated flue gas device. The catalyst with regular structure was filled in the catalyst bed.

The catalyst was loaded in an amount of 20 g. The reaction temperature was 650° C., and the reaction pressure was 0.1 MPa. The feedstock gas had a volume flow rate (STP, standard temperature and pressure) of 1000 mL/min, and a volumetric hourly space velocity of about 3000 h⁻¹. After the reactor temperature stabilized, the catalyst was first pre-treated in an N2 atmosphere for 30 min to fully remove adsorbed species on the catalyst surface. At the beginning of the reaction, the feedstock gas contained 1200 ppm vol % of NO, 1200 ppm vol % of SO₂, and the balance of N₂. The gas products were analyzed by an online infrared to obtain the concentrations of SO₂ and NO after the reaction. The results with the evaluation time of 0.5 h are listed in Table 2. The results with the evaluation time of 1.5 h are listed in Table 3.

TABLE 2
Performance comparison of different catalysts for
desulfurization and denitrification within 0.5 h

| 0.5 h total | Combination- | Combination- | Alone- | Alone- |
|---|---|---|---|---|
| conversion (%) | NO | SO₂ | NO | SO₂ |
| S-1 | 57 | 66 | <2 | 59 |
| S-2 | 44 | 37 | <2 | 35 |
| S-3 | 42 | 35 | <2 | 32 |
| S-4 | 22 | 22 | <2 | 21 |
| S-5 | 46 | 49 | <2 | 42 |
| S-6 | 41 | 50 | <2 | 46 |
| D-1 | <2 | 23 | <2 | 22 |

Note:
in Table 2, Alone-NO and Alone-SO₂ referred to that the feedstock gas only contained NO or SO₂ respectively.

TABLE 3
Performance comparison of different catalysts for
desulfurization and denitrification within 1.5 h

| 1.5 h total | Combination- | Combination- | Alone- | Alone- |
|---|---|---|---|---|
| conversion (%) | NO | SO₂ | NO | SO₂ |
| S-1 | 49 | 56 | <2 | 50 |
| S-2 | 41 | 35 | <2 | 34 |
| S-3 | 38 | 32 | <2 | 30 |
| S-4 | 20 | 20 | <2 | 20 |
| S-5 | 40 | 43 | <2 | 37 |
| S-6 | 37 | 44 | <2 | 40 |
| D-1 | <2 | 17 | <2 | 16 |

Note:
in Table 3, Alone-NO and Alone-SO₂ referred to that the feedstock gas only contained NO or SO₂ respectively.

It can be seen from the results in Table 2 and Table 3 that the catalysts provided by the present invention could effectively improve the effect in removing SOx and NOx in combination and reduce SOx and NOx emissions.

The preferred embodiments of the present invention have been described in detail above, but the present invention is not limited thereto. Within the scope of the technical concept of the present invention, a variety of simple modifications can be made to technical solutions of the present invention, including combinations of various technical features in any other suitable manner. These simple modifications and combinations should also be regarded as the disclosed content of the present invention. All belong to the protection scope of the present invention.

1. A catalyst with regular structure capable of simultaneously reducing the emission of SOx and NOx, the catalyst comprises a support with regular structure and an active component coating distributed on the inner surface and/or the outer surface of the support with regular structure, based on the total weight of the catalyst, the content of the active component coating is 1-50 wt %, the active component coating contains a matrix and an active metal component, wherein, based on the total weight of the active component coating, the content of the matrix is 10-90 wt %, the content of the active metal component is 10-90 wt %, the active metal component contains: 1) as oxide, 50-95 wt % of metal component(s) selected from Group rare earth and/or Group IIA; 2) as oxide, 5-50 wt % of non-precious metal component(s) selected from Groups VB, VIIB, VIII, IB, and IIB; 3) as element, 0.01-2 wt % of precious metal component.

2. The catalyst with regular structure according to claim 1, wherein
based on the total weight of the catalyst, the content of the active component coating is 5-40 wt %;
and/or, based on the total weight of the active component coating, the content of the matrix is 40-90 wt %, the content of the active metal component is 10-60 wt %;
and/or, the active metal component contains: 1) as oxide, 60-90 wt % of metal component(s) selected from Group rare earth and/or Group IIA; 2) as oxide, 10-40 wt % of non-precious metal component(s) selected from Groups VB, VIIB, VIII, IB, and IIB; 3) as element, 0.02-1.5 wt % of precious metal component;
preferably,
based on the total weight of the catalyst, the content of the active component coating is 10-35 wt %;
and/or, based on the total weight of the active component coating, the content of the matrix is 50-80 wt %, the content of the active metal component is 20-50 wt %;
and/or, the active metal component contains: 1) as oxide, 65-85 wt % of metal component(s) selected from Group rare earth and/or Group IIA; 2) as oxide, 15-35 wt % of non-precious metal component(s) selected from Groups VB, VIIB, VIII, IB, and IIB; 3) as element, 0.03-1.2 wt % of precious metal component.

3. The catalyst with regular structure according to claim 1, wherein the matrix is at least one of alumina, spinel, perovskite, silica-alumina, zeolite, kaolin, diatomaceous earth, and perlite, preferably at least one of alumina, spinel, and perovskite, further preferably alumina;
preferably, the support with regular structure is selected from monolithic supports with parallel channel structure open at both ends;
preferably, the cross-section of the support with regular structure has a hole density of 10-300 holes/square inch, and an opening rate of 20-80%;
preferably, said support with regular structure is at least one of cordierite honeycomb support, mullite honeycomb support, diamond honeycomb support, corundum honeycomb support, fused-zirconia-alumina honeycomb support, quartz honeycomb support, nepheline honeycomb support, feldspar honeycomb support, alumina honeycomb support and metal alloy honeycomb support.

4. The catalyst with regular structure according to claim 1, wherein
the rare earth metal component is one or more of La, Ce, Pr and Nd, preferably La and/or Ce, more preferably La;
said Group IIA metal component is one or more of Be, Mg, Ca, Sr and Ba, preferably Mg;
said non-precious metal component(s) selected from Groups VB, VIIB, VIII, IB, and IIB is one or more of Mn, Fe, Co, Ni, Cu, Zn and V, preferably at least one of Co, Fe and Mn, more preferably Mn, and Co and/or Fe, further more preferably Mn and Co;
said precious metal component is one or more of Ru, Rh, Re, Pt, Pd, Ag, Ir and Au, preferably one or more of Pt, Pd and Rh, more preferably Pd.

5. The catalyst with regular structure according to claim 1, wherein based on the total amount of said active metal components, as oxide, the ratio of the content of metal component(s) selected from Group rare earth and/or Group IIA to the content of non-precious metal component(s) selected from Groups VB, VIIB, VIII, IB, and IIB is 1-8, preferably 1.5-6, more preferably 2-4.

6. The catalyst with regular structure according to claim 1, wherein
the active metal component contains or consists of:
1a) as oxide, one or more metal components selected from Group rare earth; preferably, La;
1b) as oxide, one or more metal components selected from Group IIA, preferably, Mg;
2a) as oxide, one or more non-precious metal components selected from Groups VB, VIII, IB and IIB; preferably, Co;
2b) as oxide, one or more non-precious metal components selected from Group VIIB;
preferably, Mn;
3) as element, one or more of Pt, Pd and Rh; preferably, Pd;
preferably on the basis that the total amount of said active metal component is 100 wt %,
the content of 1a) is 30-80 wt %,
the content of 1b) is 5-40 wt %,
the content of 2a) is 3-30 wt %,
the content of 2b) is 3-20 wt %,
the content of c) is 0.01-0.2 wt %; or
preferably the molar ratio of La:Co is (1-6):1, e.g. (2.5-3.5):1.

7-8. (canceled)

9. The catalyst according to claim 1, wherein the catalyst has characteristic peaks at 2θ=33.0°±0.1°, 33.5°±0.1°, and 47.5°═0.1°, as well as 27.0°±0.1°, 28.0°±0.1°, and 39.5°±0.1° in the powder XRD spectrum.

10. (canceled)

11. The catalyst according to claim 1, wherein the catalyst is a catalyst that has been exposed to an atmosphere containing SO₂, preferably the catalyst has characteristic peaks at 2θ=28.6°±0.1°, 30.0°±0.1° and 50.4°±0.1° in the powder XRD spectrum.

12. A method for preparing a catalyst with regular structure capable of simultaneously reducing the emission of SOx and NOx, which method comprises the steps of:
(1) formulating a solution containing a precursor of metal component(s) selected from Group rare earth and/or Group IIA and a precursor of non-precious metal component(s) selected from Groups VB, VIIB, VIII, IB, and IIB;
(2) carrying out a coprecipitation reaction between the solution obtained in step (1) and a coprecipitant, and then drying and calcining the obtained solid product to obtain an active metal component precursor;
(3) mixing and slurrifying the active metal component precursor, a matrix source and water to produce an active component coating slurry;
(4) coating the support with regular structure with the active component coating slurry and drying and calcining to produce a partial-active component coating distributed on the inner surface and/or the outer surface of the support with regular structure, i.e. to obtain a semi-finished catalyst product;
(5) impregnating the semi-finished catalyst product obtained in step (4) with a solution containing a precursor of precious metal component, then drying and/or calcining to produce an active component coating distributed on the inner surface and/or the outer surface of the support with regular structure;
wherein the precursor of metal component(s) selected from Group rare earth and/or Group IIA, the precursor of non-precious metal component(s) selected from Groups VB, VIIB, VIII, IB, and IIB, the matrix source, the precursor of precious metal component, and the support with regular structure are used in such amounts that in the prepared catalyst with regular structure, based on the total weight of the catalyst, the content of the active component coating is 1-50 wt %, the active component coating contains a matrix and an active metal component, wherein, based on the total weight of the active component coating, the content of the matrix is 10-90 wt %, the content of the active metal component is 10-90 wt %, the active metal component contains: 1) as oxide, 50-95 wt % of metal component(s) selected from Group rare earth and/or Group IIA; 2) as oxide, 5-50 wt % of non-precious metal component(s) selected from Groups VB, VIIB, VIII, IB, and IIB; 3) as element, 0.01-2 wt % of precious metal component; or
wherein the precursor of metal component(s) selected from Group rare earth and/or Group IIA, the precursor of non-precious metal component(s) selected from Groups VB, VIIB, VIII, IB, and IIB, the matrix source, the precursor of precious metal component, and the support with regular structure are used in such amounts that in the prepared catalyst with regular structure, based on the total weight of the catalyst, the content of the active component coating is 5-40 wt %, the active component coating contains a matrix and an active metal component, wherein, based on the total weight of the active component coating, the content of the matrix is 40-90 wt %, the content of the active metal component is 10-60 wt %, the active metal component contains: 1) as oxide, 60-90 wt % of metal component(s) selected from Group rare earth and/or Group IIA; 2) as oxide, 10-40 wt % of non-precious metal component(s) selected from Groups VB, VIIB, VIII, IB, and IIB; 3) as element, 0.02-1.5 wt % of precious metal component; or
wherein the precursor of metal component(s) selected from Group rare earth and/or Group IIA, the precursor of non-precious metal component(s) selected from Groups VB, VIIB, VIII, IB, and IIB, the matrix source, the precursor of precious metal component, and the support with regular structure are used in such amounts that in the prepared catalyst with regular structure, based on the total weight of the catalyst, the content of the active component coating is 10-35 wt %, the active component coating contains a matrix and an active metal component, wherein, based on the total weight of the active component coating, the content of the matrix is 50-80 wt %, the content of the active metal component is 20-50 wt %, the active metal component contains: 1) as oxide, 65-85 wt % of metal component(s) selected from Group rare earth and/or Group IIA; 2) as oxide, 15-35 wt % of non-precious metal component(s) selected from Groups VB, VIIB, VIII, IB, and IIB; 3) as element, 0.03-1.2 wt % of precious metal component.

13. (canceled)

14. The preparation method according to claim 12, wherein the precursor of metal component(s) selected from Group rare earth and/or Group IIA, the precursor of non-precious metal component(s) selected from Groups VB, VIIB, VIII, IB, and IIB, the matrix source, the precursor of precious metal component, and the support with regular structure are used in such amounts that in the prepared catalyst with regular structure,
based on the total amount of said active metal components, as oxide, the ratio of the content of metal component(s) selected from Group rare earth and/or Group IIA to the content of non-precious metal component(s) selected from Groups VB, VIIB, VIII, IB, and IIB is 1-8, preferably 1.5-6, more preferably 2-4; and/or
the active metal component contains or consists of:
1a) as oxide, one or more metal components selected from Group rare earth; preferably, La;
1b) as oxide, one or more metal components selected from Group IIA, preferably, Mg;
2a) as oxide, one or more non-precious metal components selected from Groups VB, VIII, IB and IIB; preferably, Co;
2b) as oxide, one or more non-precious metal components selected from Group VIIB; preferably, Mn;
3) as element, one or more of Pt, Pd and Rh; preferably, Pd;
preferably, on the basis that the total amount of said active metal component is 100 wt %,
the content of 1a) is 30-80 wt %,
the content of 1b) is 5-40 wt %,
the content of 2a) is 3-30 wt %,
the content of 2b) is 3-20 wt %,
the content of c) is 0.01-0.2 wt %.

15. (canceled)

16. The preparation method according to claim 12, wherein the matrix source is a substance that can be transformed into the matrix under calcining in step (4);
the matrix is at least one of alumina, spinel, perovskite, silica-alumina, zeolite, kaolin, diatomaceous earth, and perlite, preferably at least one of alumina, spinel, and perovskite, further preferably alumina;
preferably, the support with regular structure is selected from monolithic supports with parallel channel structure open at both ends;
preferably, the cross-section of the support with regular structure has a hole density of 10-300 holes/square inch, and an opening rate of 20-80%;
preferably, said support with regular structure is at least one of cordierite honeycomb support, mullite honeycomb support, diamond honeycomb support, corundum honeycomb support, fused-zirconia-alumina honeycomb support, quartz honeycomb support, nepheline honeycomb support, feldspar honeycomb support, alumina honeycomb support and metal alloy honeycomb support.

17. The preparation method according to claim 12, wherein
the rare earth metal component is one or more of La, Ce, Pr and Nd, preferably La and/or Ce, more preferably La;
said Group IIA metal component is one or more of Be, Mg, Ca, Sr and Ba, preferably Mg;
said non-precious metal component(s) selected from Groups VB, VIIB, VIII, IB, and IIB is one or more of Mn, Fe, Co, Ni, Cu, Zn and V, preferably at least one of Co, Fe and Mn, more preferably Mn, and Co and/or Fe, further more preferably Mn and Co;
said precious metal component is one or more of Ru, Rh, Re, Pt, Pd, Ag, Ir and Au, preferably one or more of Pt, Pd and Rh, more preferably Pd.

18. The preparation method according to claim 12,
wherein the precursor of metal component(s) selected from Group rare earth and/or Group IIA and the precursor of non-precious metal component(s) selected from Groups VB, VIIB, VIII, IB, and IIB are each independently selected from nitrate and/or chloride of each metal component;
preferably, the coprecipitant is a carbonate salt, further preferably at least one of ammonium carbonate, potassium carbonate and sodium carbonate;
preferably, the coprecipitation reaction is carried out at pH=8-10;
preferably, the condition for calcining in step (2) includes: the temperature is 300-800° C., the time is 1-8 h; or
wherein the active component coating slurry in step (3) has a solid content of 5-45 wt %;
preferably, the condition for calcining in step (4) includes: the temperature is 300-800° C., the time is 1-5 h;
preferably, in step (5), the precursor of precious metal component is hydrolyzed in an acid solution to provide the solution;
preferably, the acid is selected from water-soluble inorganic acids and/or organic acids, preferably at least one of hydrochloric acid, nitric acid, phosphoric acid, and acetic acid;
preferably, the acid is used in such an amount that the pH value of the impregnation solution is less than 6.0, preferably less than 5.0;
preferably, the condition for calcining in step (5) includes: the temperature is 300-700° C., the time is 0.1-5 h.

19. (canceled)

20. A method for simultaneously reducing both SOx and NOx from catalytic cracking regeneration flue gas,
which method comprises: contacting the catalytic cracking regeneration flue gas with a catalyst under a condition for removing SOx and NOx, the catalyst is a catalyst according to claim 1;
preferably, the contacting is carried out in a flue gas channel provided after a cyclone separator and/or after a CO incinerator;
preferably, the condition for contacting includes: the temperature is 300-1000° C., the reaction pressure by gauge is 0-0.5 MPa, the volumetric hourly space velocity of the catalytic cracking regeneration flue gas is 200-20000 h⁻¹.

21. A method for simultaneously reducing both SOx and NOx from flue gas,
which method comprises, under a condition for removing SOx and NOx, contacting the flue gas with a catalyst, the catalyst is a catalyst according to claim 1;
preferably, the flue gas is a flue gas containing a certain concentration of SOx and NOx at the same time;
preferably, the volume fractions of SOx and NOx in the flue gas are respectively 1-3000 μL/L, the molar ratio of SOx to NOx is 0.5:1-2:1;
preferably, the condition for contacting includes: the temperature is 300-1000° C., the reaction pressure by gauge is 0-0.5 MPa, the volumetric hourly space velocity of the flue gas is 200-20000 h⁻¹.
